(19) United States
(12) Patent Application Publication
(10) Pub. No.: US 2014/0346853 A1
(43) Pub. Date: Nov. 27, 2014

(54) BRAKE FLUID PRESSURE CONTROL UNIT

(71) Applicants: DENSO CORPORATION, Kariya-city (JP); ADVICS CO., LTD., Kariya-city (JP)

(72) Inventors: Hideyuki KOIKE, Nagoya (JP); Kimiyoshi ISOGAI, Anjo-shi (JP); Yoshihiko SAWAGASHIRA, Takahama-shi (JP)

(73) Assignees: DENSO CORPORATION, Kariya-city (JP); ADVICS CO., LTD., Kariya-city (JP)

(21) Appl. No.: 14/285,892

(22) Filed: May 23, 2014

(30) Foreign Application Priority Data
May 27, 2013 (JP) 2013-111165

(51) Int. Cl. B60T 13/14

(52) U.S. Cl. CPC B60T 13/14
USPC 303/10

(57) ABSTRACT

A reservoir container has a reservoir, and a communicating passage that guides brake fluid to the reservoir. The reservoir of the reservoir container that accumulate the brake fluid is made to a hole extending in a transverse direction so that a size of the reservoir container in a height direction is made small while fully securing the capacity of the reservoir. Moreover, a horizontal plane projected area of the communicating passage is made smaller than that of the reservoir, so that a sealing part of the communicating passage is shortened, and ensures the seal integrity.

### CROSS-REFERENCE TO RELATED APPLICATION

This application is based on and claims the benefit of priority from earlier Japanese Patent Application No. 2013-111165 filed May 27, 2013, the description of which is incorporated herein by reference.

### TECHNICAL FIELD

The present disclosure relates to a brake fluid pressure control unit used for brake fluid pressure control of a vehicle such as for ABS control or for traction control, for example.

### BACKGROUND

A conventional brake fluid pressure control unit disclosed in Japanese Patent Application Laid-Open Publication No. 2004-338565 has a pump that sucks and discharges brake fluid and is accommodated in a housing.

Moreover, a bottom of the housing is closed by a pot plate and a recess-shaped reservoir is formed on the pot plate in a direction separating away from the bottom of the housing.

Furthermore, the reservoir is formed by bending or press processing, etc., and a seal member is sandwiched at a junction between the pot plate and the housing.

The brake fluid leaked out of the pump is accumulated in the reservoir.

However, since a horizontal plane projected area of the reservoir becomes large and a sealing part becomes long when trying to fully secure a capacity of a reservoir, the conventional brake fluid pressure control unit has a problem that a security of sealing is not easy.

### SUMMARY

An embodiment provides a brake fluid pressure control unit that can fully secure a capacity of a reservoir without enlarging the unit, and ensures the seal integrity.

In a brake fluid pressure control unit according to a first aspect, the brake fluid pressure control unit includes a housing, a pump system that is accommodated in the housing and pressurizes and discharges brake fluid, a reservoir container that is fixed to a bottom of the housing and accumulates the brake fluid that is leaked out from the pump system, and a sealing member disposed at a connection part of the housing and the reservoir container and prevents the brake fluid that flows into the reservoir container from the housing from leaking out.

The housing has a pump accommodation space in which the pump system is accommodated, and a brake fluid guiding passage that guides the brake fluid leaked out from the pump system to the pump accommodation space to a bottom of the housing.

The reservoir container has a reservoir constituted of a hole that extends in a transverse direction from one end of the reservoir container and a lid that closes an opening of the hole, and a communicating passage that communicates the brake fluid guiding passage and the reservoir.

A horizontal plane projected area of the communicating passage is smaller than a horizontal plane projected area of the reservoir.

Accordingly, since the reservoir is a hole extending in a transverse direction, a size of the reservoir container in a height direction can be made smaller while fully securing the capacity of the reservoir compared with a configuration that the reservoir is a hole extending in a vertical direction, and thus can avoid enlargement of the brake fluid pressure control unit.

Further, since the horizontal plane projected area of the communicating passage is smaller than that of the reservoir a sealing part becomes short and sealing can be easily secured.

In the brake fluid pressure control unit according to a second aspect, the reservoir has a circular cross-section, the communicating passage is connected to a circumference surface of the reservoir, and an axis of the communicating passage does not cross an axis of the reservoir.

In the brake fluid pressure control unit according to a third aspect, a longitudinal direction of the housing in planar view and a longitudinal direction of the reservoir container in planar view match.

In the brake fluid pressure control unit according to a fourth aspect, there is provided a communicating pipe of which one end thereof is inserted into the brake fluid guiding passage, while another end thereof is inserted into the communicating passage.

In the brake fluid pressure control unit according to a fifth aspect, the sealing member is disposed between an inner circumference surface of the brake fluid guiding passage and a perimeter surface of the communicating pipe, and the sealing member is disposed between an inner circumference surface of the communicating passage and a perimeter surface of the communicating pipe.

In the brake fluid pressure control unit according to a sixth aspect, the sealing member is sandwiched by the housing and the reservoir container.

### BRIEF DESCRIPTION OF THE DRAWINGS

In the accompanying drawings:

FIG. 1 shows an elevational view of a brake fluid pressure control unit in an embodiment of the present disclosure;

FIG. 2 shows a bottom view of the unit in FIG. 1;

FIG. 3 shows an enlarged sectional view of a section A of FIG. 1; and

FIG. 4 shows a sectional view of a principal part of a modification of the brake fluid pressure control unit in the embodiment of the present disclosure.

### DETAILED DESCRIPTION OF THE PREFERABLE EMBODIMENTS

With reference to the accompanying drawings, hereinafter will be described embodiments of the present disclosure.

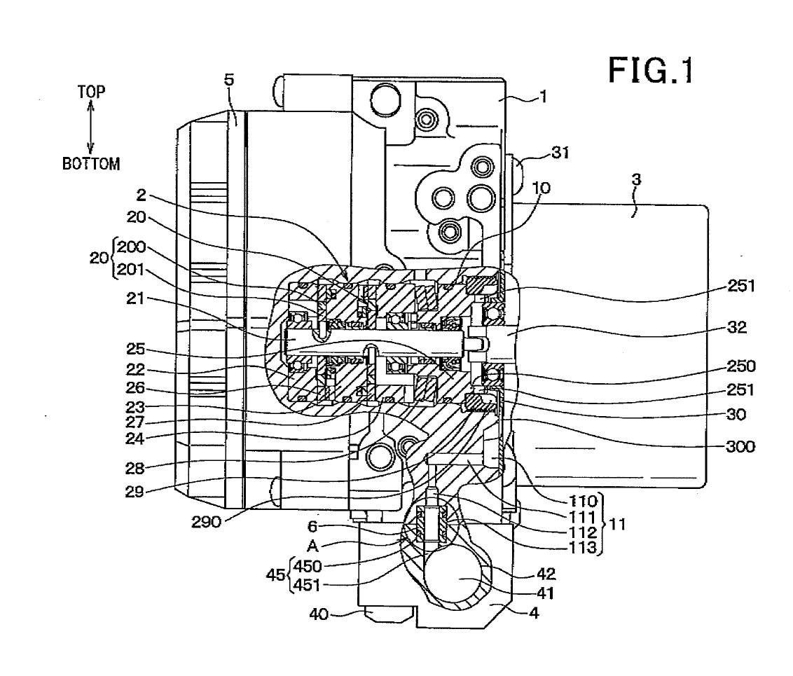

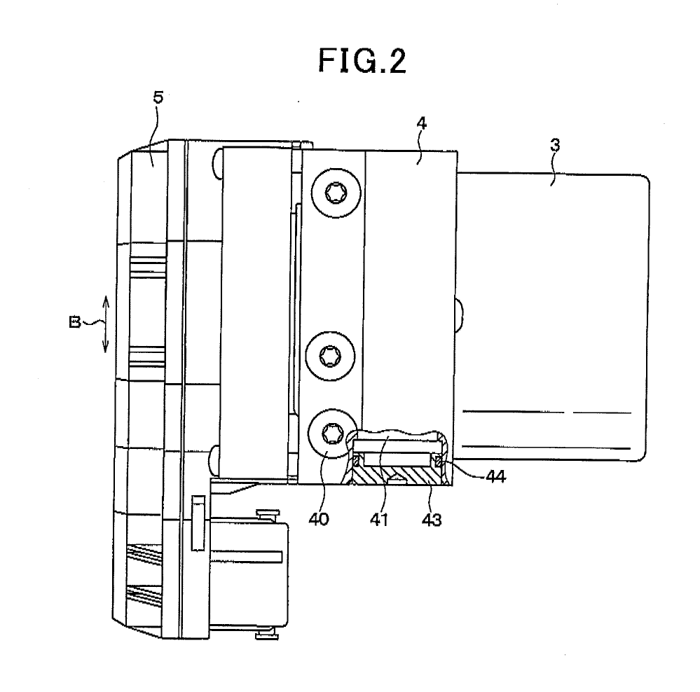

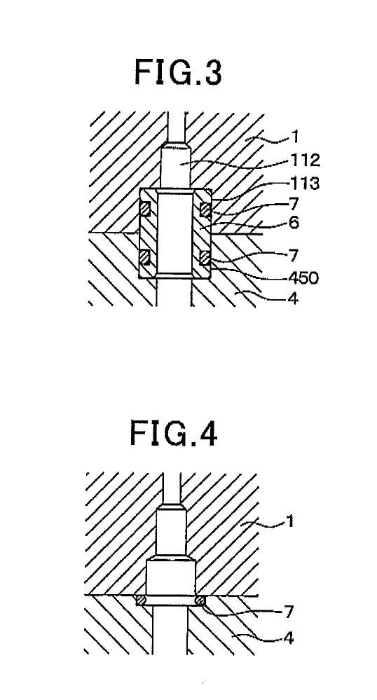

A brake fluid pressure control unit shown in FIG. 1 to FIG. 3 is composed of components such as a housing 1, a pump system 2, an electric motor 3, a reservoir container 4, a plurality of electromagnetic valves (not shown), an electrical control unit (not shown). The unit is attached to a vehicle so that a top-bottom direction of FIG. 1 becomes an actual top and bottom direction.

The pump system 2 pressurizes and discharges brake fluid. The electric motor 3 drives a pump 20 of the pump system 2. The reservoir container 4 accumulates the brake fluid that is leaked out from the pump system 2. The electromagnetic valves open and close brake fluid passages where the brake fluid circulates. The electrical control unit controls operations of the electric motor, the electromagnetic valves, etc., and is covered with a cover 5.

The housing 1 is made of an aluminum alloy having substantially rectangular parallelepiped shape, and is formed with many brake fluid passages where the brake fluid circulates.

Six ports (not shown) that communicate with the brake fluid passages are formed on a surface of the housing 1.

Four ports among the six are connected to each wheel cylinder (not shown) corresponding to each of four wheels in the vehicle, and the remaining two ports are connected to a master cylinder (not shown) of the vehicle.

A pump accommodation space 10 is formed in the housing 1. The pump accommodation space 10 is a space having a cylindrical shape and one end thereof is opened while another end is closed.

The pump accommodation space 10 extends horizontally.

Further, the pump system 2 (details will be mentioned later) is accommodated in the pump accommodation space 10.

In addition, in planar view, a length of the housing 1 in a direction B perpendicular to an axis of the pump accommodation space 10 is longer than a length of the housing 1 in an axial direction of the pump accommodation space 10. Hereinafter, the direction B is called a housing longitudinal direction B.

Moreover, a brake fluid guiding passage 11 that guides the brake fluid leaked out from the pump system 2 to the pump accommodation space 10 to a bottom of the housing 1 is formed in the housing 1.

The brake fluid guiding passage 11 is composed of a guiding recess 110, a guiding horizontal hole 111, a guiding vertical hole 112, and a pipe inserting vertical hole 113.

The guiding recess 110 is located in an end of the opening side of the pump accommodation space 10, and is under the opening of the pump accommodation space 10.

The guiding horizontal hole 111 is extended in a direction parallel to the pump accommodation space 10 (that is, extended horizontally) from the bottom of the guiding recess 110.

The guiding vertical hole 112 is extended downwardly from near a bottom end of the guiding horizontal hole 111.

The pipe inserting vertical hole 113 is a cylindrical shaped space extended downwardly from a lower end of the guiding vertical hole 112, and opens to the bottom of the housing 1.

The electric motor 3 is disposed at an end of the housing 1 so as to close the opening of the pump accommodation space 10, and is fixed to the housing 1 by screws 31 using a holder 30 of the electric motor 3.

An end of a driving shaft 32 of the electric motor 3 is projected into the pump accommodation space 10.

A brake system of the vehicle in which the brake fluid pressure control unit of the present embodiment is used is composed of two lines, namely, a first brake pipe line and a second brake pipe line.

For this reason, the pump system 2 has two pumps 20 that suck and discharge the brake fluid.

The pump 20 is constituted by a trochoid pump having an outer rotor 200 that internal teeth are formed in an inner circumference thereof, and an inner rotor 201 that external teeth are formed in a perimeter thereof.

A driving shaft 21 is inserted into a hole of the inner rotor 201, and the driving shaft 21 and the inner rotor 201 are connected by a key.

The driving shaft 21 of the pump system 2 is engaged with the driving shaft 32 of the electric motor 3, and the pump 20 is driven by the electric motor 3 via the driving shaft 21 of the pump system 2.

The internal teeth and the external teeth formed in each of the outer rotor 200 and the inner rotor 201 are meshed together to form a plurality of spaces.

Sucking and discharging of the brake fluid is performed by a size of the spaces changing caused by a rotation of the driving shaft 21.

A casing that constitutes an external form of the pump system 2 is composed of a first, second, third, and fourth cylinders 22-25 and cylindrical first and second central plates 26, 27.

The first cylinder 22, the first central plate 26, the second cylinder 23, the second central plate 27, and the third cylinder 24 are stacked in this order, and a perimeter of overlapped portion are welded to join these components;

A welded and unitarized part as a first case and the fourth cylinder 25 as a second case are disposed coaxially having a plate spring 28 sandwiched between the third cylinder 24 of the first case and the second case.

One of the pumps 20 is disposed in a rotor chamber formed by sandwiching both sides of the cylindrical first central plate 26 by the first cylinder 22 and the second cylinder 23.

Moreover, another one of the pumps 20 is disposed in a rotor chamber formed by sandwiching both sides of the cylindrical second central plate 27 by the second cylinder 23 and the third cylinder 24.

The cases, the pumps 20 and the like formed into integral structure are inserted into the pump accommodation space 10 of the housing 1.

Then, it has a composition that the pump system 2 is fixed to the housing 1 by fastening an annular male screw member 29 to an entrance of the pump accommodation space 10.

At least one through hole 251 is formed in cylindrical portion 250 of the fourth cylinder 25.

One of the through holes 251 is located in a lowermost part of the cylindrical portion 250.

An annular groove 290 that communicates with the through hole 251 is formed in the male screw member 29.

A communicating recess 300 that communicates the groove 290 of the male screw member 29 and the guiding recess 110 of the housing 1 is formed in the holder 30 of the electric motor 3.

The brake fluid leaked out from the pump system 2 to the pump accommodation space 10, more specifically, the brake fluid leaked out from the pump 20 to a space in the cylindrical portion 250 of the fourth cylinder 25 through gaps between the case and the driving shaft 21 is guided to the guiding recess 110 of the housing 1 via the through hole 251 of the fourth cylinder 25, the groove 290 of the male screw member 29, and the communicating recess 300 of the holder 30 of the electric motor 3.

The reservoir container 4 is made of an aluminum alloy having substantially rectangular parallelepiped shape, and is fixed to the bottom of the housing 1 with a plurality of screws 40.

In planar view of the reservoir container 4, the housing longitudinal direction B is longer than the length of housing 1 in the axial direction of the pump accommodation space 10.

In other words, the longitudinal direction B of the housing 1 in planar view and the longitudinal direction of the reservoir container 4 in planar view match.

The reservoir container 4 has a reservoir 41 that accumulates the brake fluid that leaks out from the pump system 2.

This reservoir 41 is constituted of a hole 42, which is a cylindrical space with a circular cross-section, that extends in a transverse direction (i.e., substantially horizontal direction) along the housing longitudinal direction B from one end of the reservoir container 4 in the housing longitudinal direction B, and a lid 43 that closes an opening of the hole 42.

An O ring 44 is disposed at a perimeter of the lid 43 in order to prevent the brake fluid accumulated in the reservoir 41 from leaking out. In addition, the hole 42 is formed by machining.

A communicating passage 45 that communicates the brake fluid guiding passage 11 and the reservoir 41 is formed in the reservoir container 4.

The communicating passage is composed of a pipe inserting vertical hole 450 and a communicating vertical hole 451.

The pipe inserting vertical hole 450 is a space having a cylindrical shape and extends downwardly from an upper surface of the reservoir container 4.

The communicating vertical hole 451 is a space having a cylindrical shape and extends downwardly from a lower end of the pipe inserting vertical hole 450, and opens to a circumference surface of the reservoir 41.

In planar view, the communicating passage 45 is disposed in a position that its axis does not cross an axis of the reservoir 41.

Moreover, an inner diameter of the communicating passage 45 is smaller than that of the reservoir 41, and a horizontal plane projected area of the communicating passage 45 is smaller than that of the reservoir 41.

A cylindrical communicating pipe 6 having a through hole is disposed at a connection part of the housing 1 and the reservoir container 4.

One end of the communicating pipe 6 is inserted into the pipe inserting vertical hole 113 of the brake fluid guiding passage 11, while another end thereof is inserted into the pipe inserting vertical hole 450 of the communicating passage 45.

O rings 7 as sealing members are disposed between an inner circumference surface of the pipe inserting vertical hole 113 of the brake fluid guiding passage 11 and a perimeter surface of the communicating pipe 6, and between an inner circumference surface of the pipe inserting vertical hole 450 of the communicating passage 45 and a perimeter surface of the communicating pipe 6 in order to prevent the brake fluid that flows into the reservoir container 4 from the housing 1 from leaking out.

The pump 20 is driven by the electric motor 3 when controlling an ABS or traction, for example, in the brake fluid pressure control unit with a composition mentioned above.

Thereby, the pump 20 sucks and pressurizes the brake fluid, and then discharges the brake fluid.

A very small amount of the brake fluid leaks out from the pump 20 to the space in the cylindrical portion 250 of the fourth cylinder 25 through the gaps between the case of the pump system 2 and the driving shaft 21 during the operation of the pump 20.

The brake fluid leaked out to the space in the cylindrical portion 250 of the fourth cylinder 25 is guided to the reservoir 41 via the through hole 251 of the fourth cylinder 25, the groove 290 of the male screw member 29, the communicating recess 300 of the holder 30 of the electric motor 3, the brake fluid guiding passage 11, and the communicating passage 45, and is accumulated in the reservoir 41.

According to the brake fluid pressure control unit of the present embodiment, the following effects can be obtained.

Since the reservoir 41 is a hole extending in a transverse direction, a size of the reservoir container 4 in a height direction can be made smaller while fully securing the capacity of the reservoir 41 compared with a configuration that the reservoir 41 is a hole extending in a vertical direction, and thus can avoid enlargement of the brake fluid pressure control unit.

Moreover, since the hole 42 is formed by machining, its accuracy of dimension is satisfactory.

Further, since the horizontal plane projected area of the communicating passage 45 is smaller than that of the reservoir 41, a sealing part of the communicating passage 45 becomes short and sealing can be easily secured.

Moreover, since the communicating passage 45 is disposed in the position that its axis does not cross the axis of the reservoir 41 in planar view, it becomes easy to secure disposing spaces of the O rings 7 disposed at parts of the communicating passage 45, while the size of the reservoir container 4 in the height direction can be made small.

Furthermore, since the longitudinal direction B of the housing 1 in planar view and the longitudinal direction of the reservoir container 4 in planar view match, the reservoir 41 can be made longer.

Therefore, predetermined capacity can be secured even if the reservoir 41 is made with the small diameter, and the size of the reservoir container 4 in the height direction can be made small by the small diameter.

Moreover, when fixing the reservoir container 4 to the housing 1 with the plurality of screws 40, since the longitudinal direction B of the housing 1 in planar view and the longitudinal direction of the reservoir container 4 in planar view match, intervals between the screws 40 in the housing longitudinal direction B can be widened so that the reservoir container 4 can be fixed stably, thus looseness by vibration etc. can be prevented reliably.

Further, by the communicating pipe 6 of which one end thereof is inserted into the pipe inserting vertical hole 113 of the brake fluid guiding passage 11, while another end thereof is inserted into the pipe inserting vertical hole 450 of the communicating passage 45, positions of both the pipe inserting vertical holes 113 and 450 can be prevented from deviating.

In addition, although the O rings 7 are disposed between the inner circumference surface of the pipe inserting vertical hole 113 of the brake fluid guiding passage 11 and the perimeter surface of the communicating pipe 6, and between the inner circumference surface of the pipe inserting vertical hole 450 of the communicating passage 45 and the perimeter surface of the communicating pipe 6 in order to prevent the brake fluid that flows into the reservoir container 4 from the housing 1 from leaking out in the above embodiment, an O ring 7 may be sandwiched by the housing 1 and the reservoir container 4 as a modification shown in FIG. 4.

Accordingly, a sealing structure can be made small and simple.

Moreover, in the modification shown in FIG. 4, a copper packing may be used as a sealing member instead of the O ring 7.

### Other Embodiments

Although the trochoid pump is used as the pump 20 in the above-mentioned embodiments, other revolving pumps or reciprocating pumps may be used for the pump 20.

In addition, the present disclosure is not limited to the above-mentioned embodiments, and can be suitably modified within limits disclosed in the claims.

Moreover, each above-mentioned embodiment is not mutually unrelated, and can be combined suitably except for a case of being clearly improper.

Further, in the above-mentioned embodiments, elements that constitute the embodiment are not necessarily indispensable except for cases where clearly shown that it is especially indispensable and thought theoretically that it is clearly indispensable etc.

Furthermore, in the above-mentioned embodiments, when numerical values, such as the number of the component, a numerical value, quantity, and a range of the embodiment are mentioned, it is not limited to the specific number except for cases where clearly shown that it is especially indispensable, and it is theoretically limited to a specific number clearly etc.

Moreover, when mentioning shapes or spatial relationship, etc., of elements in the above-mentioned embodiments, it is not in particular limited to the shapes, or spatial relationship, etc. except for cases where clearly shown and when it is theoretically limited to specific shapes, spatial relationship, etc.,

What is claimed is:

1. A brake fluid pressure control unit comprising:
a housing;
a pump system that is accommodated in the housing, and pressurizes and discharges brake fluid;
a reservoir container that is fixed to a bottom of the housing, and accumulates the brake fluid that is leaked out from the pump system; and
a sealing member disposed at a connection part of the housing and the reservoir container, which prevents the brake fluid that flows into the reservoir container from the housing from leaking out; wherein,
the housing has a pump accommodation space in which the pump system is accommodated, and a brake fluid guiding passage that guides the brake fluid leaked out from the pump system to the pump accommodation space to a bottom of the housing;
the reservoir container has a reservoir constituted of a hole that extends in a transverse direction from one end of the reservoir container and a lid that closes an opening of the hole, and a communicating passage that communicates the brake fluid guiding passage and the reservoir; and
a horizontal plane projected area of the communicating passage is smaller than a horizontal plane projected area of the reservoir.

2. The brake fluid pressure control unit according to claim 1, wherein,
the reservoir has a circular cross-section;
the communicating passage is connected to a circumference surface of the reservoir; and
an axis of the communicating passage does not cross an axis of the reservoir.

3. The brake fluid pressure control unit according to claim 1, wherein, a longitudinal direction of the housing in planar view and a longitudinal direction of the reservoir container in planar view match.

4. The brake fluid pressure control unit according to claim 1, wherein,
there is provided a communicating pipe (6) of which one end thereof is inserted into the brake fluid guiding passage, while another end thereof is inserted into the communicating passage.

5. The brake fluid pressure control unit according to claim 4, wherein,
the sealing member is disposed between an inner circumference surface of the brake fluid guiding passage and a perimeter surface of the communicating pipe, and
the sealing member is disposed between an inner circumference surface of the communicating passage and a perimeter surface of the communicating pipe.

6. The brake fluid pressure control unit according to claim 1, wherein,
the sealing member is sandwiched by the housing and the reservoir container.
